(19) United States
(12) Patent Application Publication
(10) Pub. No.: US 2023/0115216 A1
(43) Pub. Date: Apr. 13, 2023

(54) Utilization Of Coordinate Systems For Compression And Encryption

(71) Applicant: Theon Technologies, Inc., Newport Beach, CA (US)

(72) Inventor: Robert Edward Grant, Laguna Beach, CA (US)

(21) Appl. No.: 17/497,893

(22) Filed: Oct. 9, 2021

(51) Int. Cl. H04L 9/06; G06F 21/60

(52) U.S. Cl. CPC H04L 9/06; G06F 21/606; H04L 2209/34

(57) ABSTRACT

A numeric string of information is encoded into a graphic using first and second lines or other designations of length. The information can be decoded by measuring the first and second lengths, and then recreating the numeric string by applying a mathematical formula to the measured lengths. Lines can be touching or not touching, can have any angular relationship between them, and can be curved. Alphabetic and other non-numeric information can be translated into numbers, and then included in the numeric string being encoded. Numeric strings can be extremely long, and for example can be used as multi-million digit passcodes. A given graphic can contain more than two lines or other designations of lengths, which can be separately decoded, or can be used to assist in decoding of each other. All suitable mathematical formulae can be used, including for example, simple multiplication and division, addition, subtraction, roots, exponents, and logarithms. Different recipients having access to different mathematical formulae can derive different pieces of information from a single graphic.

### FIELD OF THE INVENTION

The field of the invention is data security.

### BACKGROUND

The background description includes information that may be useful in understanding the present invention. It is not an admission that any of the information provided herein is prior art or relevant to the presently claimed invention, or that any publication specifically or implicitly referenced is prior art.

It is commonplace to encode information (i.e., data) in an image. For example, bar codes QR codes encode in lines and dots. Digital photographs, and even charts and graphs are similar, encoding information in a rasterized series of bits or bytes.

Generally speaking, the information in rendered bar codes, QR codes, photographs, charts, and graphs are not confidential to a viewer, because the process of rendering (e.g., printing on a physical piece of paper, or displaying on a display screen), to the viewer. It is possible to hide confidential information as a code within an image, as for example, a hidden water mark. In known such cases, the code is an arrangement of dots (or pixels in a digital representation), which are spatially separated to avoid detection.

Issues can arises as to the amount of information that can be stored in a simple encoding. For example, a simple 20 line bar code can only store 20 binary digits. A more complicated QR or image can encode thousands or millions of digits, but of course are the cost of greater complexity. Moreover, each such encoding scheme only encodes for a single sequence.

In modern cryptography, it can be useful to transmit keys tens of thousands of characters, and in future embodiments keys are contemplate that contain millions or even higher numbers of characters. Thus, there is a need for systems and methods of transmitting complex cryptographic keys and other information with only simple formats.

### SUMMARY OF THE INVENTION

The inventive subject matter provides apparatus, systems and methods in which information (i.e., data) is represented as a numeric string, which is encoded into a graphical representation using first and second lengths, such that a mathematical relationship between the first and second lengths defines at least a portion of the numeric string. The information can be decoded by measuring the first and second lengths, determining a number as a function of the measured first and second lengths, wherein the number corresponds with at least a portion of the data.

In a very simple example, the string of data “0.14285714” can be represented by lines have relative lengths 7 and 1. On a cartesian coordinate, the lines could extend orthogonally from a common point, which might or might not be the 0,0 point. In other embodiments the lines need not be orthogonal, and they do not even need to be linear. In some embodiments the lengths can be represented by dots (or pixels) rather than filled in lines.

The data being encoded can include alphabetic and other non-numeric characters, and for example could be used as a link to the Internet or other data store. Encoded data can also be extremely long, as when a graphic contains designations of lengths that are manipulated by a mathematical formula to represent a multi-million digit one-time passcode. The number string being encoded could, for example, be part of an irrational or transcendental number.

As used herein, the term “graphical representation” means any representation from which a human or machine could obtain measurements of lengths, whether the lengths are designated by lines, relative positions of dots or pixels, or in any other manner. As such, graphical representations include images of graphs or drawings specifically created to include lines or other designations of specific lengths that are intended to encode messages, pass codes, or other information. Graphical representations also include stored images of the type that one might take with a camera or cell phone, as well as printed versions of same, which are then modified to add designations of two or more lengths, in which the added designations encode messages, pass codes, or other information. The term “graphic” is used herein as a shortcut for “graphical representation”.

All suitable mathematical formulae can be used, including for example, simple multiplication and division, addition, subtraction, roots, exponents, and logarithms. In a preferred embodiment, the number N derived from lengths L1 and L2 can be calculated as N²=L1²+L2².

Still further, it is contemplated that different recipients of a graphical representation could utilize different formulae against the same lengths to arrive at different numbers and different decoded data. In that manner different messages could be sent to different recipients. Similarly, multiple lengths can be represented by lines, intersections, or free floating points in an graphic, which are recognizable to an intended recipient of the graphic, but which might be overlooked by a non-intended recipient. In that manner vast

Various objects, features, aspects and advantages of the inventive subject matter will become more apparent from the following detailed description of preferred embodiments.

### BRIEF DESCRIPTION OF THE DRAWING

FIG. 1 is a flow diagram of a method of encoding and decoding data using first and second lengths in a graphical representation.

FIG. 2 is an example of a graphical representation encoding the word “HELP” using two lengths.

FIG. 3 is an example of a graphical representation encoding the irrational number 0.142857 . . . using dots at positions 1,1 and 1,7 in a cartesian coordinate graph.

FIG. 4 is an example of graphical representation encoding several different pieces of information.

FIG. 5 is a flow diagram of encoding and decoding the word “HELP” using precision measuring software.

FIG. 6 is a simplistic line drawing of a sailboat, in which the relative lengths of the mast and the boom are used to encode information.

### DETAILED DESCRIPTION

Throughout the following discussion, references are be made regarding processors. It should be appreciated that the use of that terms is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, as used herein the term processor encompasses one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps.

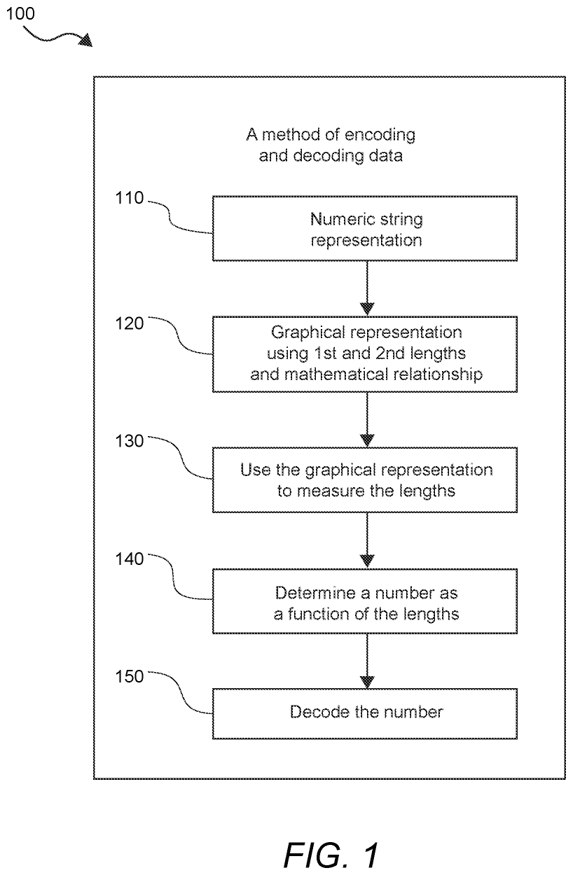

FIG. 1 is a flow diagram of a method 100 of encoding and decoding data using first and second lengths in a graphical representation. Although abbreviated in the figure, the steps are the elements of claim 1 as originally filed, namely:
“representing a first set of the data as a numeric string” 110;
“creating a graphical representation using at least first and second lengths, such that a mathematical relationship between the first and second lengths defines at least a portion of the numeric string” 120;
“using the graphical representation to measure the first and second lengths”130;
“determining a number as a function of the measured first and second lengths” 140; and
“decoding the number to produce at least a portion of the first set of data” 150.

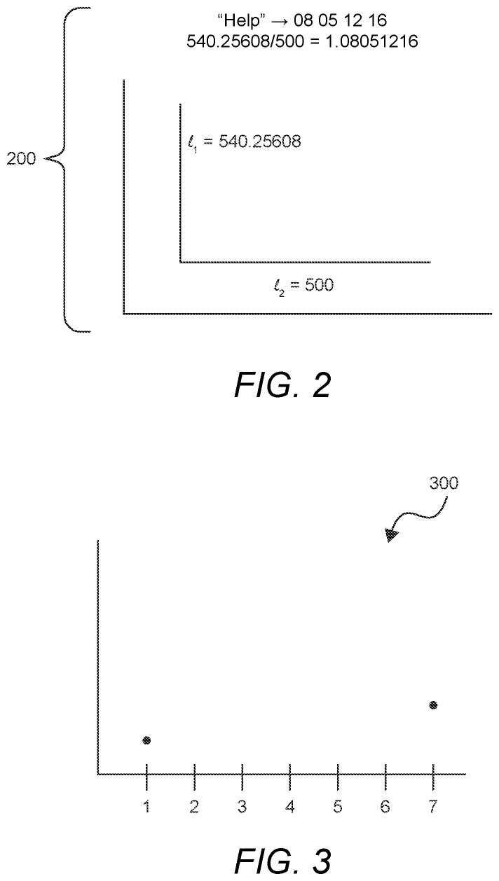

FIG. 2 is an example of a graphical representation 200 with accompanying caption that encodes the information “HELP” using two length L1 and L2. Here, a simple alphabetic to numeric cypher is used to encode the information, in which the letters correspond with the numbers 8, 5, 12, and 16, respectively. Lines of relative lengths 54025608 and 500 are related by simple division to arrive at the number 1.08051216, which can then be decoded to the original information, HELP.

The number 1 is added to the beginning of the number string to prevent the sequence from being interpreted as 8051216, since the numbers 80, 51, 21 would be nonsensical using the reverse cypher.

It is contemplated that any suitable conversion could be used to convert non-numeric data into a numeric format. Even very long text strings, such as chapter of a book, could theoretically be encoded in this manner.

Although this example involves encoding text into line lengths using a simple division, any suitable mathematical formula could be used, including for example, multiplication, square root or other roots, exponents, and logarithms.

It should also be appreciated that the coordinate system has no tic marks that a recipient could use to determine the relative lengths of L1 and L2. Such tic marks are not necessary where line lengths are measured using precision measuring software.

FIG. 3 is an example of a graphical representation encoding the irrational number 0.142857 . . . using dots at positions 1,1 and 1,7 in a cartesian coordinate graph. This figure demonstrates that lengths used in encoding and decoding information can be represented by dots 310, 312 (or pixels in a digital format), without actually showing the filled in lines.

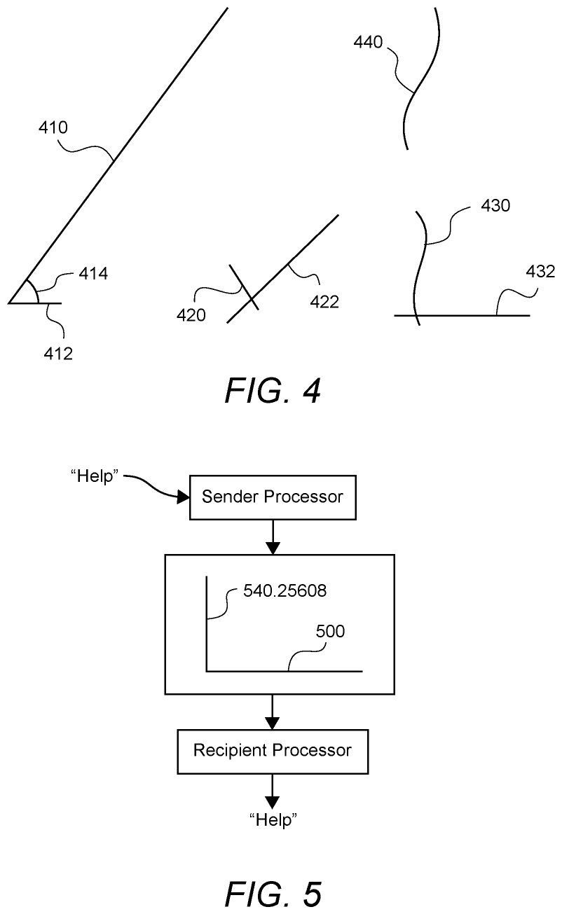

FIG. 4 is an example of graphical representation encoding several different pieces of information. In this case, first information is encoded in lengths of the lines 410 and 412, and second information is encoded in the angle 414 between the lines. The angle 414 could, for example, be used to identify which formula should be used to decode information from the lengths of lines 410 and 412. Using lengths of lines at angles other than 90° provides a greater spread of relative line lengths when the graphical representation is stored in a typical image format.

Still other lines in FIG. 4 encode other information. Lines 420 and 422 encode third information, and lines 430 and 432 encode fourth information. Line 440 is not obviously coupled with any of the other lines, but could still be used to encode fifth information when coupled with, for example, line 430.

Decoding of the line lengths is preferably accomplished using precision measuring software (not shown). Such software may well be needed when measuring lengths of curved lines such as line 440.

it is still further contemplated that widths, colors, or other characteristics of lines could be used additionally or alternatively to encode information, and might for example, be used to identify which formula should be used to decode information from the line lengths.

FIG. 5 is a flow diagram of encoding and decoding the word “HELP” using precision measuring software. This diagram tracks the steps of FIG. 1, albeit in a different format. Here, a sender processor 520 represents data “HELP” as a numeric string, and creates a graphic 520 in which a mathematical formula between first and second lengths of lines defines at least a portion of the numeric string. A recipient processor 530, preferably using precision measuring software, measures the lengths of the first and second lines, and uses a reverse mathematical formula to produce a number, which is then decoded to the word HELP.

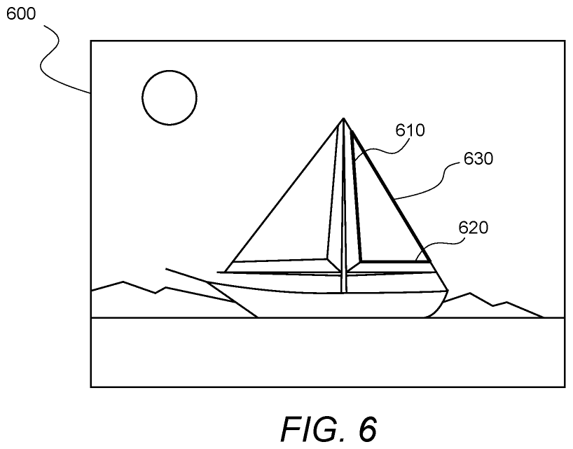

FIG. 6 is a simplistic line drawing of a sailboat 600, in which the relative lengths of the mast 610 and the boom 620 are used to encode information. Depending on the formula used, the information in this particular example might also be determined from the length of the leech edge 620 of the sail.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of encoding and decoding data, comprising:
representing a first set of the data as a numeric string;
creating a graphical representation using at least first and second lengths, such that a mathematical relationship between the first and second lengths defines at least a portion of the numeric string;
using the graphical representation to measure the first and second lengths;
determining a number as a function of the measured first and second lengths; and
decoding the number to produce at least a portion of the first set of data.

2. The method of claim 1, wherein the graphical representation comprises first and second positions on a cartesian coordinate, and wherein the first and second lengths are equal to perpendicular distances from a common point.

3. The method of claim 1, wherein the graphical representation comprises first, second, and third positions on a coordinate system, and wherein the first and second lengths are equal to first and second distances, respectively, from the third point.

4. The method of claim 3, wherein an angle formed between the first and third positions,
and the second and third positions, is not equal to 90°.

5. The method of claim 3, wherein a numeric representation of the angle composes
at least a portion of the numeric string.

6. The method of claim 1, wherein at least some of the first set of data include non-numeric characters, and wherein the step of representing a first set of the data as a numeric string further comprising converting the non-numeric characters to corresponding numeric digits.

7. The method of claim 1, wherein at least one of the first and second lengths is depicted in the graphical representation as a line.

8. The method of claim 1, wherein the line is at least partially curved.

9. The method of claim 1, wherein the first set of data is at least part of a decryption key.

10. The method of claim 1, further comprising encoding second first set of the data as a second numeric string, and including in the graphical representation a third length, wherein a second mathematical relationship between the first and third lengths defines at least a portion of the second numeric string.

11. The method of claim 1, further comprising using precision measuring software to measure the first and second lengths.

12. A method of communicating data among at least a first sender and a first recipient, comprising the first sender utilizing a processor to execute instructions to:
convert an at least partially non-numeric data set to a numeric value;
construct first and second lines having relative sizes that correspond to the numeric value via a mathematical function;
create a graphical representation that includes the first and second lines; and
provide the encrypted graphical representation to the first recipient.

13. The method of claim 12, wherein the mathematical the function comprises at least one of multiplication and division.

14. The method of claim 12, further comprising the recipient utilizing a second processor to execute instructions to:
use precision measuring software to determine the relative lengths of the first and second lines;
use a reverse a reverse mathematical function to determine the numeric value from the relative lengths of the first and second lines; and
use a reverse conversion routine to convert the numeric value to the at least partially non-numeric data set.

15. The method of claim 12, wherein the first and second lines are configured as first and second sides of a right triangle, and the relative sizes of the first and second lines are selected such that a length of a third side of the right triangle corresponds with the numeric value.

16. The method of claim 12, further comprising encrypting the graphical representation.

17. The method of claim 16, further comprising using a partial key pass code to encrypt the graphical representation.

18. The method of claim 12, further comprising
modifying the graphical representation with additional lines having relative lengths that correspond with an additional numeric value and an additional data set;
storing the modified graphical representation in a data store, and encoding access to the modified graphical representation by the first sender and the first recipient, and at least one other sender and at least one other recipient.

19. A method of storing and retrieving information in which a first portion of the information is encoded in relative lengths of lines in a graphical representation.

20. The method of claim 19 in which the first portion of the information corresponds to a numerical value obtained by a first mathematical function against the relative lengths of the lines.

21. The method of claim 19 in which a second portion of the information corresponds to a second numerical value obtained by a second mathematical function against the relative lengths of the lines, and the second mathematical function is different from the first mathematical function.

22. The method of claim 21, further comprising a first user executing the first mathematical operation against the relative lengths of the lines to ascertain the first numerical value and the first portion of the information, and a second user executing the second mathematical operation against the relative lengths of the lines to ascertain the second numerical value and the second information.

23. A method of storing and retrieving information in which a first mathematical formula other than a binary base conversion is used to decode a graphic to obtain a first portion of the information, and a second mathematical formula is used to decode the graphic to obtain a second portion of the information different from the first portion of the information.

24. The method of claim 23, in which the first mathematical formula comprises a ratio.

25. The method of claim 23, in which the first mathematical formula comprises at least one of a multiplication, a division, a root, an exponent, and a log.
